(19) United States
(12) Patent Application Publication
(10) Pub. No.: US 2007/0032641 A1
(43) Pub. Date: Feb. 8, 2007

(54) Mixtures of reactive dyes and their use

(76) Inventors: Athanassios Tzikas, Pratteln (CH); Georg Roentgen, Freiburg (DE); Laszlo Fekete, Magden (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/576,056

(22) PCT Filed: Oct. 11, 2004
(86) PCT No.: PCT/EP04/52489

§ 371 Date: Apr. 18, 2006

(30) Foreign Application Priority Data
Oct. 20, 2003 (EP) 03103865.6

(51) Int. Cl. C09D 11/00; C09B 46/00

(52) U.S. Cl. 534/887; 106/31.52; 106/31.48; 106/31.51

(57) ABSTRACT

Dye mixtures comprising at least one dye of formula (1) together with at least one dye from the group of formulae (2a) and (2b), wherein the radicals are as defined in the claim, are suitable for dyeing or printing cellulosic fibre materials while having a good build-up behaviour and yield dyeings of a deep shade having good fastness properties.

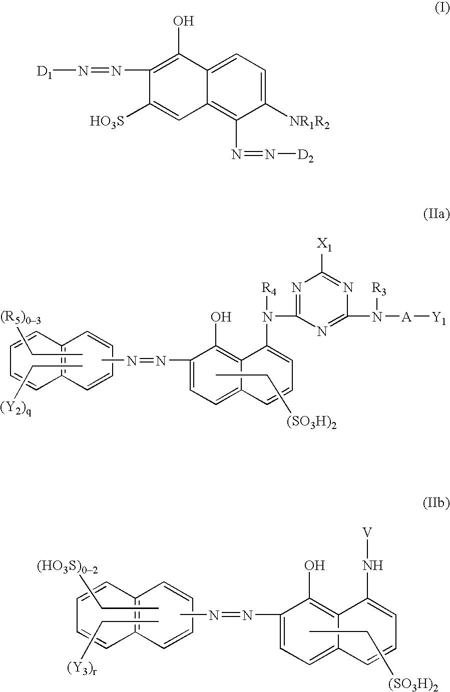

The present invention relates to mixtures of reactive dyes, which mixtures are suitable for dyeing or printing nitrogen-containing or hydroxy-group-containing fibre materials and yield dyeings or prints having good all-round fastness properties.

The practice of dyeing has recently led to higher demands being made on the quality of the dyeings and the profitability of the dyeing process. As a result, there continues to be a need for novel, readily obtainable dyeing compositions having good properties, especially in respect of their application.

Dyeing today requires reactive dyes that, for example, have sufficient substantivity and at the same time exhibit good ease of washing-off of unfixed dye. In addition, they should exhibit a good colour yield and a high reactivity, the objective being especially to obtain dyeings having high degrees of fixing. In many cases, the build-up behaviour of reactive dyes is not sufficient to meet the demands, especially in the dyeing of very deep shades.

The problem underlying the present invention is therefore to provide new mixtures of reactive dyes, which mixtures are especially suitable for dyeing and printing fibre materials and which possess the above-described qualities to a high degree. They should also yield dyeings having good all-round fastness properties, for example fastness to light and to wetting.

The present invention accordingly relates to dye mixtures comprising at least one dye of formula 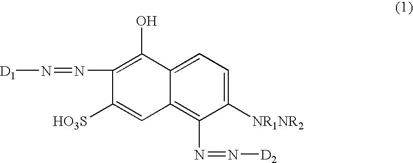
together with at least one dye from the group of formulae 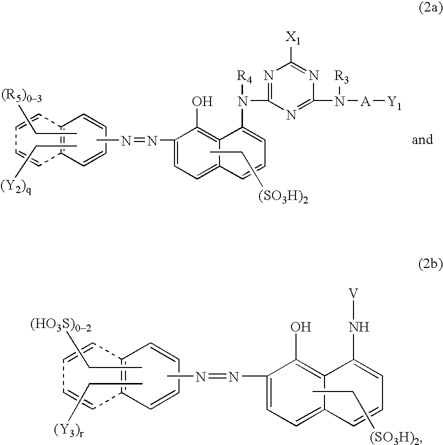
wherein
R₁ and R₂ are each independently of the other hydrogen or unsubstituted or substituted C₁-C₈alkyl,
R₃ and R₄ are each independently of the other hydrogen or unsubstituted or substituted C₁-C₄alkyl,
(R₅)₀₋₃ denotes from 0 to 3 identical or differing substituents from the group halogen, C₁-C₄alkyl, C₁-C₄alkoxy, carboxy, nitro and sulfo,
A is unsubstituted or substituted phenylene, unsubstituted or substituted naphthylene, or C₂-C₈alkylene which may be interrupted by oxygen,
D₁ and D₂ are each independently of the other the radical of a diazo component of the benzene or naphthalene series,
q and r are each independently of the other the number 0 or 1,
X₁ is halogen or a non-fibre-reactive substituent, and
Y₁ and Y₂ are each independently of the other a radical of formula
   —SO₂—Z (3a),
   —NH—CO—(CH₂)ₘ—SO₂—Z (3b),
   —CONH—(CH₂)ₙ—SO₂—Z (3c),
   —NH—CO—CH(Hal)—CH₂-Hal (3d),
   —NH—CO—C(Hal)═CH₂ (3e) or 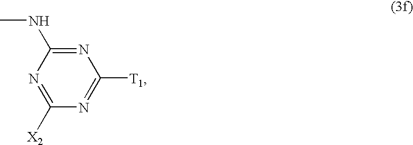
   wherein
X₂ is halogen, T₁ independently has the definition of X₂, is a non-fibre-reactive substituent or is a fibre-reactive radical of formula
   —NH—(CH₂)₂₋₃—SO₂—Z (4a),
   —NH—(CH₂)₂₋₃—O—(CH₂)₂₋₃—SO₂—Z (4b), 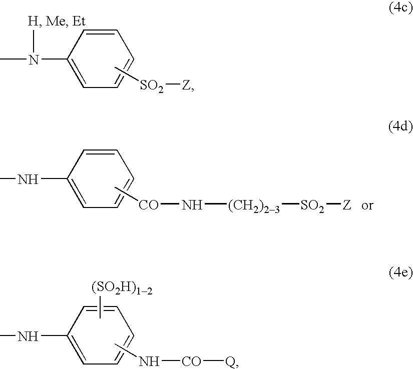
   wherein
Z is vinyl or a radical —CH₂—CH₂U and U is a group that is removable under alkaline conditions,
Q is a group —CH(Hal)—CH₂-Hal or —C(Hal)═CH₂,
m and n are each independently of the other the number 2, 3 or 4,
Hal is halogen,
Y₃ is a radical of the above-mentioned formula (3a), or is a radical of formula 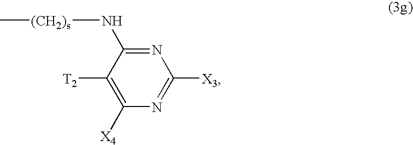
   wherein
s is the number 0 or 1, and
X₃ is halogen or C₁-C₄akylsulfonyl,
X₄ is halogen or C₁-C₄alkyl and
T₂ is hydrogen, cyano or halogen, and
V is C₂-C₄alkanoyl, benzoyl which is unsubstituted or is substituted by a radical of formula (3g), or is a radical of formula 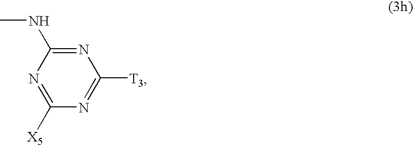
   wherein
X₅ is halogen, and
T₃ is a non-fibre-reactive substituent.

The diazo components in the dyes of formulae (2a) and (2b) are a phenyl radical or a naphthyl radical.

In the radical of formula (4c), Me is the methyl radical and Et is the ethyl radical. The mentioned radicals come into consideration, besides hydrogen, as substituents at the nitrogen atom.

As C₁-C₈alkyl there comes into consideration for R₁ and R₂ each independently of the other e.g. methyl, ethyl, propyl, isopropyl, butyl, sec-butyl, tert-butyl, isobutyl, n-pentyl, n-hexyl, n-heptyl or n-octyl. A C₁-C₄alkyl radical is of interest. The mentioned alkyl radicals may be unsubstituted or may be substituted e.g. by hydroxy, sulfo, sulfato, cyano, carboxy, C₁-C₄alkoxy or phenyl, preferably hydroxy, sulfato, C₁-C₄alkoxy or phenyl. Preference is given to the corresponding unsubstituted radicals.

As C₁-C₄alkyl there comes into consideration for R₃ and R₄ each independently of the other e.g. methyl, ethyl, propyl, isopropyl, butyl, sec-butyl, tert-butyl or isobutyl, preferably methyl or ethyl and especially methyl. The mentioned alkyl radicals may be unsubstituted or may be substituted e.g. by hydroxy, sulfo, sulfato, cyano or carboxyl. Preference is given to the corresponding unsubstituted radicals.

Preferably, one of the radicals R₁ and R₂ is hydrogen and the other is one of the previously mentioned, unsubstituted or substituted C₁-C₈alkyl radicals. Preferably, R₄ is hydrogen and R3 is hydrogen or one of the previously mentioned, unsubstituted or substituted C₁-C₄alkyl radicals.

More especially, R₁ and R₂ are hydrogen.

More especially, R₄ is hydrogen and R₃ is hydrogen, methyl or ethyl.

Preferably, (R₅)₀₋₃ denotes from 0 to 3 identical or differing substituents from the group halogen, C₁-C₄alkyl, C₁-C₄alkoxy and sulfo.

When the diazo component in the dye of formula (2a) is a naphthyl radical, there come into consideration for (R₅)₀₋₃ from 1 to 3, and especially 1 or 2, sulfo groups. The naphthyl radical is bonded to the azo group preferably in the 2-position.

When the diazo component in the dye of formula (2a) is a phenyl radical, there come into consideration for (R₅)₀₋₃ from 0 to 3, preferably from 0 to 2, identical or differing substituents from the group chlorine, methyl, methoxy and sulfo.

q is preferably the number 0.

The radicals D₁ and D₂ in the dye mixtures according to the invention may contain the substituents that are customary for azo dyes.

From the range of substituents there may be mentioned by way of example: alkyl groups having from 1 to 12 carbon atoms, especially from 1 to 4 carbon atoms, such as methyl, ethyl, n- or iso-propyl, or n-, iso-, sec- or tert-butyl; alkoxy groups having from 1 to 8 carbon atoms, especially from 1 to 4 carbon atoms, such as methoxy, ethoxy, n- or iso-propoxy, or n-, iso-, sec- or tert-butoxy; C₁-C₄alkoxy substituted in the alkyl moiety, for example by hydroxy, C₁-C₄alkoxy or sulfato, e.g. 2-hydroxyethoxy, 3-hydroxypropoxy, 2-sulfatoethoxy, 2-methoxyethoxy or 2-ethoxyethoxy; alkanoylamino groups having from 2 to 8 carbon atoms, especially C₂-C₄alkanoylamino groups, such as acetylamino or propionylamino; benzoyl-amino or C₂-C₄alkoxycarbonylamino groups, such as methoxycarbonylamino or ethoxycarbonylamino; amino; N-mono- or N,N-di-C₁-C₄alkylamino which is unsubstituted or is substituted in the alkyl moiety, for example by hydroxy, sulfo, sulfato or C₁-C₄alkoxy, e.g. methylamino, ethylamino, N,N-dimethyl- or N,N-diethylamino, sulfomethylamino, β-hydroxy-ethylamino, N,N-di(β-hydroxyethylamino), N-β-sulfatoethylamino; phenylamino which is unsubstituted or is substituted in the phenyl moiety by methyl, methoxy, halogen or sulfo; N-C₁-C₄alkyl-N-phenylamino which is unsubstituted or is substituted in the alkyl moiety by hydroxy, sulfo or sulfato or in the phenyl moiety by methyl, methoxy, halogen or sulfo, e.g. N-methyl-N-phenylamino, N-ethyl-N-phenylamino, N-β-hydroxyethyl-N-phenylamino or N-β-sulfoethyl-N-phenylamino; naphthylamino which is unsubstituted or is substituted by sulfo; alkanoyl groups having from 2 to 8 carbon atoms, especially from 2 to 4 carbon atoms, for example acetyl or propionyl; benzoyl; alkoxycarbonyl having from 1 to 4 carbon atoms in the alkoxy radical, such as methoxycarbonyl or ethoxycarbonyl; alkylsulfonyl having from 1 to 4 carbon atoms, such as methylsulfonyl or ethylsulfonyl; phenyl- or naphthyl-sulfonyl; trifluoromethyl, nitro, cyano, hydroxy, halogen, such as fluorine, chlorine or bromine; carbamoyl, N-C₁-C₄alkylcarbamoyl, such as N-methylcarbamoyl or N-ethylcarbamoyl; sulfamoyl, N-C₁-C₄-alkylsulfamoyl, such as N-methylsulfamoyl, N-ethylsulfamoyl, N-propylsulfamoyl, N-isopropylsulfamoyl or N-butylsulfamoyl; N-(β-hydroxyethyl)-sulfamoyl, N,N-di(P-hydroxyethyl)sulfamoyl, N-phenylsulfamoyl, ureido, carboxy, sulfomethyl, sulfo or sulfato as well as fibre-reactive radicals. The alkyl radicals may, in addition, be interrupted by oxygen (—O—) or by an amino group (—NH—, —N(C₁-C₄alkyl)-).

In one embodiment of the present invention that is of interest, at least one of the radicals D₁ and D₂ carries at least one fibre-reactive group.

In another embodiment of the present invention that is of interest, each of the radicals D₁ and D₂ carries at least one fibre-reactive group.

Fibre-reactive radicals are to be understood as being those that are capable of reacting with the hydroxy groups of cellulose, with the amino, carboxy, hydroxy and thiol groups in wool and silk, or with the amino and possibly the carboxy groups of synthetic polyamides to form covalent chemical bonds. The fibre-reactive radicals are generally bonded to the dye radical directly or via a bridging member. Suitable fibre-reactive radicals are, for example, those having at least one removable substituent on an aliphatic, aromatic or heterocyclic radical, or those wherein the mentioned radicals contain a radical suitable for reaction with the fibre material, such as, for example, a vinyl radical.

Such fibre-reactive radicals are known per se and a large number of them have been described, for example in Venkataraman “The Chemistry of Synthetic Dyes” Volume 6, pages 1-209, Academic Press, New York, London 1972 or in U.S. Pat. No. 5,684,138.

Preferably, D₁ and D₂ are each independently of the other a radical of formula 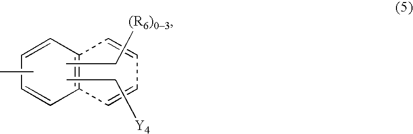
wherein
(R₆)₀₋₃ denotes from 0 to 3 identical or differing substituents from the group halogen, C₁-C₄-alkyl, C₁-C₄alkoxy, carboxy, nitro and sulfo, especially halogen, C₁-C₄alkyl, C₁-C₄alkoxy and sulfo, and
Y₄ is a radical of the above-mentioned formula (3a), (3b), (3c), (3d), (3e) or (3f).

As halogen there comes into consideration for R₅ and R₆ e.g. fluorine, chlorine, bromine or iodine, preferably chlorine or bromine and especially chlorine.

As C₁-C₄alkyl there comes into consideration for R₅ and R₆ e.g. methyl, ethyl, n-propyl, isopropyl, n-butyl, sec-butyl, isobutyl or tert-butyl, preferably methyl or ethyl and especially methyl.

As C₁-C₄alkoxy there comes into consideration for R₅ and R₆ e.g. methoxy, ethoxy, n-propoxy, isopropoxy, n-butoxy, isobutoxy or tert-butoxy, preferably methoxy or ethoxy and especially methoxy.

T₁ is preferably a non-fibre-reactive substituent or is a fibre-reactive radical of formula (4a), (4b), (4c), (4d) or (4e).

When T₁ is a non-fibre-reactive substituent, it may be, for example, hydroxy; C₁-C₄alkoxy; C₁-C₄alkylthio which is unsubstituted or is substituted e.g. by hydroxy, carboxy or sulfo; amino; amino mono- or di-substituted by C₁-C₈alkyl, wherein the alkyl is unsubstituted or is further substituted e.g. by sulfo, sulfato, hydroxy, carboxy or phenyl, especially by sulfo or hydroxy, and may be interrupted one or more times by the radical —O—; cyclohexylamino; morpholino; N-C₁-C₄alkyl-N-phenylamino or phenylamino or naphthylamino, wherein phenyl or naphthyl is unsubstituted or is substituted e.g. by C₁-C₄alkyl, C₁-C₄alkoxy, carboxy, sulfo or halogen.

Examples of suitable non-fibre-reactive substituents T₁ are amino, methylamino, ethylamino, β-hydroxyethylamino, N-methyl-N-β-hydroxyethylamino, N-ethyl-N-β-hydroxyethylamino, N,N-di-β-hydroxyethylamino, β-sulfoethylamino, cyclohexylamino, morpholino, 2-, 3- or 4-chlorophenylamino, 2-, 3- or 4-methylphenylamino, 2-, 3- or 4-methoxyphenylamino, 2-, 3- or 4-sulfophenylamino, disulfophenylamino, 2-, 3- or 4-carboxyphenylamino, 1- or 2-naphthylamino, 1-sulfo-2-naphthylamino, 4,8-disulfo-2-naphthylamino, N-ethyl-N-phenylamino, N-methyl-N-phenylamino, methoxy, ethoxy, n- or iso-propoxy and hydroxy.

As a non-fibre-reactive radical, T₁ is preferably defined as being C₁-C₄alkoxy, C₁-C₄alkylthio which is unsubstituted or is substituted by hydroxy, carboxy or sulfo, hydroxy, amino, N-mono- or N,N-di-C₁-C₄alkylamino which is unsubstituted or is substituted in the alkyl moiety by hydroxy, sulfato or sulfo, morpholino, phenylamino which is unsubstituted or is substituted in the phenyl ring by sulfo, carboxy, acetylamino, chlorine, methyl or methoxy, or N—C₁-C₄-alkyl-N-phenylamino which is unsubstituted or is substituted in the same manner, wherein the alkyl is unsubstituted or is substituted by hydroxy, sulfo or sulfato, or naphthylamino which is unsubstituted or is substituted by from 1 to 3 sulfo groups.

Especially preferred non-fibre-reactive radicals T₁ are amino, N-methylamino, N-ethylamino, N-β-hydroxyethylamino, N-methyl-N-β-hydroxyethylamino, N-ethyl-N-β-hydroxyethylamino, N,N-di-β-hydroxyethylamino, β-sulfoethylamino, morpholino, 2-, 3- or 4-carboxyphenylamino, 2-, 3- or 4-sulfophenylamino or N-C₁-C₄alkyl-N-phenylamino.

For the radical T₃, the definitions and preferred meanings mentioned for T₁ when it is a non-fibre-reactive radical apply. T₃ is especially morpholino or 2-, 3- or 4-sulfophenylamino.

In the case of fibre-reactive radicals T₁ of formulae (4a) and (4b), Z is preferably β-chloroethyl. In the case of fibre-reactive radicals T₁ of formulae (4c) and (4d), Z is preferably vinyl or β-sulfatoethyl.

When T₁ is a fibre-reactive radical, T₁ is preferably a radical of formula (4c) or (4d) and especially of formula (4c).

Hal in the fibre-reactive radicals of formulae (3d), (3e) and (4e) is preferably chlorine or bromine, especially bromine.

When X₁ in the dye of formula (2a) is halogen, there comes into consideration, for example, fluorine, chlorine or bromine.

When X₁ in the dye of formula (2a) is a non-fibre-reactive substituent, there comes into consideration, for example, the definition given above for T₁ when it is a non-fibre-reactive substituent, the preferred meaning given for T₁ applying.

Preferably, X₁ is halogen, especially fluorine or chlorine and more especially chlorine.

X₂ in the fibre-reactive radical of formula (3f) is, for example, fluorine, chlorine or bromine, preferably fluorine or chlorine and especially chlorine.

T₂, X₃ and X₄ as halogen are, for example, fluorine, chlorine or bromine, especially chlorine or fluorine.

X₃ as C₁-C₄alkylsulfonyl is, for example, ethylsulfonyl or methylsulfonyl and especially methylsulfonyl.

X4 as C₁-C₄alkyl is, for example, methyl, ethyl, n- or iso-propyl, n-, iso- or tert-butyl and especially methyl.

X₃ and X4 are preferably each independently of the other chlorine or fluorine.

T₂ is preferably hydrogen, cyano or chlorine.

X₅ in the fibre-reactive radical of formula (3h) is, for example, fluorine, chlorine or bromine, preferably fluorine or chlorine and especially chlorine.

Preferably, V is benzoyl which is unsubstituted or is substituted in the phenyl ring by a radical of the above-mentioned formula (3g), or is a radical of the above-mentioned formula (3h) wherein for X₃, X₄, X₅, T₂, T₃ and s the above-mentioned definitions and preferred meanings apply.

As the leaving group U there comes into consideration, for example, —Cl, —Br, —F, —OSO₃H, —SSO₃H, —OCO—CH₃, —OPO₃H₂, —OCO—C₆H₅, —OSO₂—C₁-C₄alkyl or —OSO₂—N(C₁-C₄alkyl)₂. Preferably, U is a group of formula —Cl, —OSO₃H, —SSO₃H, —OCO—CH₃, —OCO-C₆H₅ or —OPO₃H₂, especially —Cl or —OSO₃H and most preferably —OSO₃H.

Examples of suitable radicals Z are accordingly vinyl, β-bromo- or β-chloro-ethyl, β-acetoxyethyl, β-benzoyloxyethyl, β-phosphatoethyl, β-sulfatoethyl and β-thiosulfatoethyl. Z is preferably vinyl, β-chloroethyl or β-sulfatoethyl.

Preferably, D₁ and D₂ are each independently of the other a radical of formula 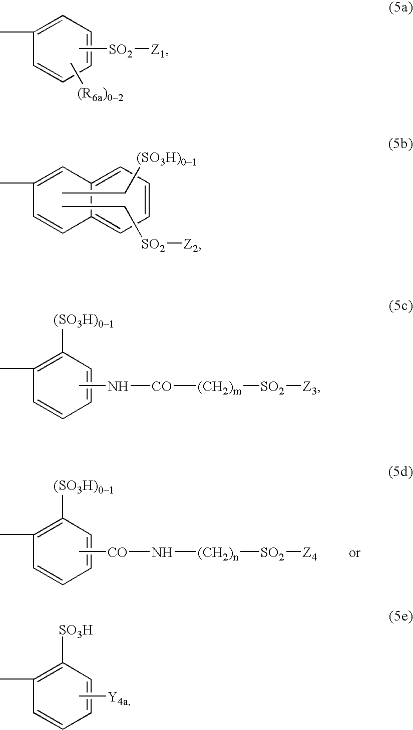
preferably of formula (5a), (5b) or (5e), wherein
(R₆ₐ)₀₋₂ denotes from 0 to 2 identical or differing substituents from the group halogen,
C₁-C₄alkyl, C₁-C₄alkoxy and sulfo, especially methyl, methoxy and sulfo,
Y₄ₐ is α,β-dibromopropionylamino or α-bromoacryloylamino,
m is the number 2 or 3, especially 3,
n is the number 2 or 3, especially 2, and
Z₁, Z₂, Z₃ and Z₄ are each independently of the others vinyl, β-chloroethyl or β-sulfatoethyl.
Z₁ and Z₂ are preferably each independently of the other vinyl or β-sulfatoethyl.

Z₃ is preferably β-chloroethyl or β-sulfatoethyl, especially β-chloroethyl.

Z₄ is preferably β-chloroethyl or β-sulfatoethyl, especially β-sulfatoethyl.

When A in the dyes of formula (2a) is an unsubstituted or substituted phenylene radical or naphthylene radical, there come into consideration as substituents, for example, identical or differing radicals from the group halogen, C₁-C₄alkyl, C₁-C₄alkoxy and sulfo, preferably C₁-C₄alkyl, C₁-C₄alkoxy and sulfo and especially methyl, methoxy and sulfo. In that case, the fibre-reactive radical Y₁ is a radical of formula (3a), (3b), (3c), (3d), (3e) or (3f), preferably of formula (3a) or (3c) and especially of formula (3a).

When A in the dyes of formula (2a) is a C₂-C₈alkylene radical which may be interrupted by oxygen, there comes into consideration, for example, ethylene, propylene, isopropylene, butylene, isobutylene, —(CH₂)₂—O—(CH₂)₂—, —(CH₂)₃—O—(CH₂)₂— or —(CH₂)₃—O—(CH₂)₃—. In that case, the fibre-reactive radical Y, is preferably a radical of formula (3a). A preferred C₂-C₈-alkylene which may be interrupted by oxygen, such as, for example, a radical of formula —(CH₂)₂₋₄—O—(CH₂)₂₋₄—, is a C₂-C₆alkylene radical which may be interrupted by oxygen, such as, for example, —(CH₂)₂—O—(CH₂)₂—, —(CH₂)₃—O—(CH₂)₂— or —(CH₂)₃—O—(CH₂)₃—, and especially a C₂-C₄alkylene radical which may be interrupted by oxygen, such as, for example, —(CH₂)₂—O—(CH₂)₂—.

In a preferred embodiment of the dye mixtures according to the invention, the radical -A—Y₁ is a radical of the above-mentioned formula (5a), (5b), (5c), (5d) or (5e) or a radical of formula
—(CH₂)₂₋₄—O—(CH₂)₂₋₄—SO₂—Z₅ (5f),
wherein
Z₅ is vinyl, β-chloroethyl or β-sulfatoethyl, especially vinyl or β-chloroethyl.

In an especially preferred embodiment of the dye mixtures according to the invention, the radical -A—Y, in the dye of formula (2a) is a radical of formula (5a), (5b) or (5c), preferably of formula (5a) or (5b) and especially of formula (5a).

Preference is given to the dyes of formula (1) wherein
D₁ and D₂ are each independently of the other a radical of formula (5a), (5b), (5c), (5d) or (5e), preferably of formula (5a), (5b) or (5e), and especially of formula (5a), and
R₁ and R₂ are hydrogen.

The radicals D₁ and D₂ in the dyes of formula (1) are identical or non-identical, preferably non-identical.

Special preference is given to the dyes of formula (1) wherein
R₁ and R₂ are hydrogen,
D₁ is a radical of formula 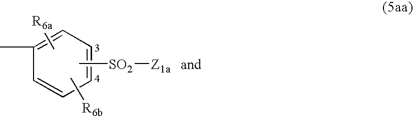
D₂ is a radical of formula 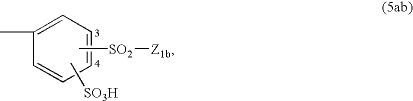
   wherein
R₆ₐ and R_{6b} are each independently of the other methyl or methoxy, and
Z₁ₐ and Z_{1b} are each independently of the other vinyl, β-chloroethyl or β-sulfatoethyl.

As a dye of formula (1) there also comes into consideration a dye mixture that comprises at least one compound of formulae (1a) and (1b) 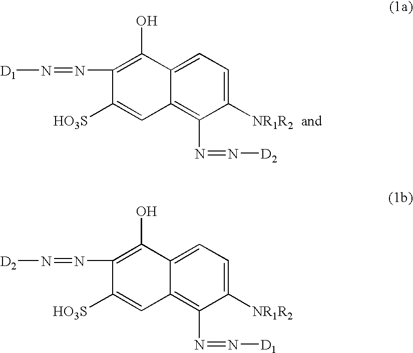
together with at least one compound of formulae (1c) and (1d) 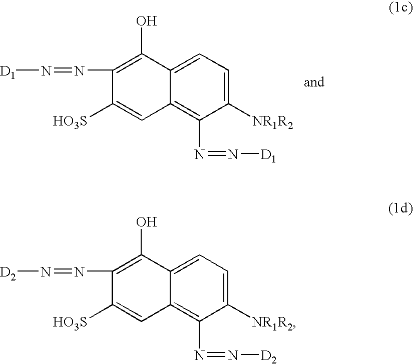
wherein
D₁ and D₂ are non-identical, and
R₁, R₂, D₁ and D₂ have the definitions and preferred meanings given above.

Preferably, the dye of formula (2a) in the dye mixtures according to the invention is a dye of formula 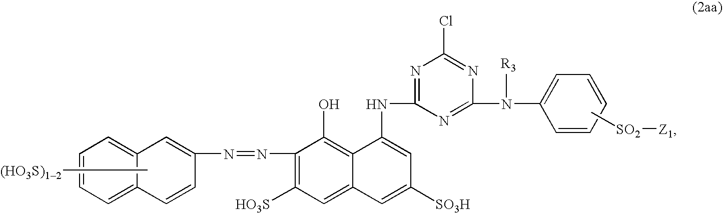
wherein
R₃ is hydrogen, methyl or ethyl, and
Z₁ is vinyl, β-chloroethyl or β-sulfatoethyl.

As a dye of formula (2b) there come into consideration, for example, the dyes of formulae

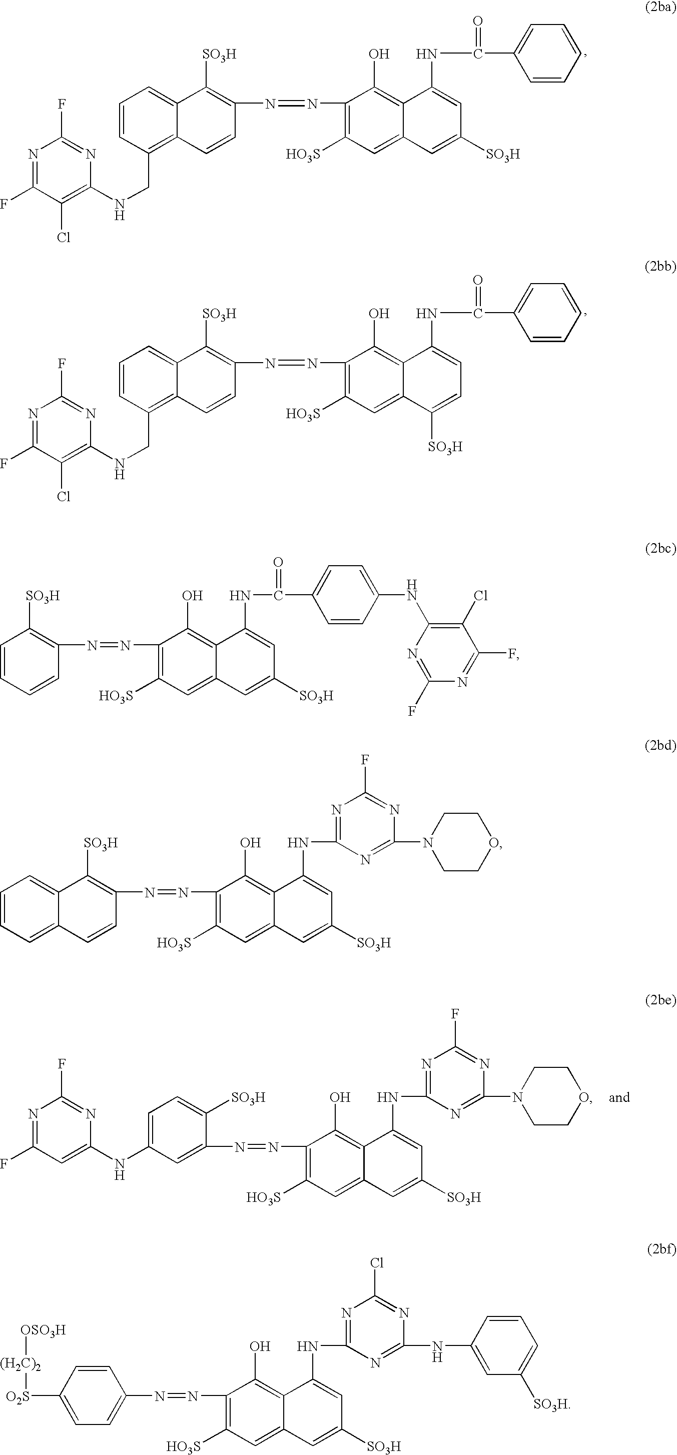

In one embodiment of interest, the dye mixtures according to the invention comprise at least one dye of formula (1) together with at least one dye of formula (2a).

The reactive dyes of formulae (1), (2a) and (2b) in the dye mixtures according to the invention comprise sulfo groups each of which is either in the form of the free sulfonic acid or, preferably, in the form of a salt thereof, for example in the form of the sodium, lithium, potassium or ammonium salt, or in the form of a salt of an organic amine, for example in the form of the triethanolammonium salt.

The reactive dyes of formulae (1), (2a) and (2b) and hence also the dye mixtures may comprise further additives, for example sodium chloride or dextrin.

In the dye mixture according to the invention, the dyes of formula (1) are in a weight ratio to the dyes of formula (2a) and/or (2b) of, for example, from 1:99 to 99:1, preferably from 5:95 to 95:5 and especially from 10:90 to 90:10.

The dyes of formulae (1), (2a) and (2b) are known or may be prepared by methods known per se. Dyes of formula (1) are disclosed, for example, in WO-A-00/06652. Dyes of formula (2a) are described, for example, in Kokai JP 50-000178.

The dye mixtures according to the invention may be prepared, for example, by mixing the individual dyes. That mixing process is carried out, for example, in suitable mills, for example ball mills or pin mills, and also in kneaders or mixers.

The dye mixtures according to the invention may, where appropriate, comprise other auxiliaries that, for example, improve handling or increase storage stability, such as, for example, buffers, dispersants or humectants. Such auxiliaries are known to the person skilled in the art.

The dye mixtures according to the invention are suitable for dyeing and printing an extremely wide variety of materials, especially hydroxyl-group-containing or nitrogen-containing fibre materials. Examples are paper, silk, leather, wool, polyamide fibres and polyurethanes and also especially cellulosic fibre materials of all kinds. Such fibre materials are, for example, the natural cellulosic fibres, such as cotton, linen and hemp, and also cellulose and regenerated cellulose. The dye mixtures according to the invention are also suitable for dyeing or printing hydroxyl-group-containing fibres present in blend fabrics, e.g. mixtures of cotton with polyester fibres or polyamide fibres.

The present invention accordingly relates also to the use of the dye mixtures according to the invention in the dyeing or printing of hydroxyl-group-containing or nitrogen-containing, especially cellulosic, fibre materials.

The dye mixtures according to the invention can be applied to the fibre material and fixed to the fibre in a variety of ways, especially in the form of aqueous dye solutions and dye print pastes. They are suitable both for the exhaust process and for dyeing in accordance with the pad-dyeing process; they can be used at low dyeing temperatures and require only short steaming times in the pad-steam process. The build-up behaviour is very good, the degrees of fixing are high and unfixed dye can be washed off easily, the difference between the degree of exhaust and the degree of fixing being remarkably small, that is to say the soaping loss is very low. The dye mixtures according to the invention are also suitable for printing, especially on coffon, and also for printing nitrogen-containing fibres, for example wool or silk or blend fabrics that contain wool.

The dyeings and prints produced using the dye mixtures according to the invention can be reproduced very well, have a high tinctorial strength and a high fibre-to-dye binding stability in both the acidic and the alkaline range, and furthermore have good fastness to light and very good wet-fastness properties, such as fastness to washing, to water, to sea water, to cross-dyeing and to perspiration. Fibre-level and surface-level dyeings are obtained.

The dye mixtures according to the invention are also suitable as colorants for use in recording systems. Such recording systems are, for example, commercially available inkjet printers for paper or textile printing, or writing instruments, such as fountain pens and ballpoint pens and especially inkjet printers. For that purpose the dye mixture according to the invention is first brought into a form suitable for use in recording systems. A suitable form is, for example, an aqueous ink that comprises the dye mixture according to the invention as colorant. The inks can be prepared in customary manner by mixing together the individual constituents in the desired amount of water.

Substrates that come into consideration include the above-mentioned hydroxyl-group-containing or nitrogen-containing fibre materials, especially cellulosic fibre materials.

The dyes used in the aqueous inks should preferably have a low salt content, that is to say they should have a total content of salts of less than 0.5% by weight, based on the weight of the dyes. Dyes that have relatively high salt contents as a result of their preparation and/or as a result of the subsequent addition of diluents can be desalted, for example, by membrane separation procedures, such as ultrafiltration, reverse osmosis or dialysis.

The inks preferably have a total content of dyes of from 1 to 35% by weight, especially from 1 to 30% by weight and preferably from 1 to 20% by weight, based on the total weight of the ink. The preferred lower limit in this case is a limit of 1.5% by weight, preferably 2% by weight and especially 3% by weight.

The inks may comprise water-miscible organic solvents, for example C₁-C₄alcohols, e.g. methanol, ethanol, n-propanol, isopropanol, n-butanol, sec-butanol, tert-butanol or iso-butanol; amides, e.g. dimethylformamide or dimethylacetamide; ketones or ketone alcohols, e.g. acetone, diacetone alcohol; ethers, e.g. tetrahydrofuran or dioxane; nitrogen-containing heterocyclic compounds, e.g. N-methyl-2-pyrrolidone or 1,3dimethyl-2-imidazolidone, poly-alkylene glycols, e.g. polyethylene glycol, or polypropylene glycol; C₂-C₆alkylene glycols and thioglycols, e.g. ethylene glycol, propylene glycol, butylene glycol, triethylene glycol, thio-diglycol, hexylene glycol and diethylene glycol; other polyols, e.g. glycerol or 1,2,6hexane-triol; and C₁-C₄alkyl ethers of polyhydric alcohols, e.g. 2-methoxyethanol, 2-(2-methoxy-ethoxy)ethanol, 2-(2-ethoxyethoxy)ethanol, 2-[2-(2-methoxyethoxy)ethoxy]-ethanol or 2-[2-(2-ethoxyethoxy)ethoxy]ethanol; preferably N-methyl-2-pyrrolidone, diethylene glycol, glycerol or especially 1,2-propylene glycol, usually in an amount of from 2 to 30% by weight, especially from 5 to 30% by weight and preferably from 10 to 25% by weight, based on the total weight of the ink.

In addition, the inks may also comprise solubilisers, e.g. ε-caprolactam.

The inks may comprise thickeners of natural or synthetic origin inter alia for the purpose of adjusting the viscosity.

Examples of thickeners that may be mentioned include commercially available alginate thickeners, starch ethers or locust bean flour ethers, especially sodium alginate on its own or in admixture with modified cellulose, e.g. methylcellulose, ethylcellulose, carboxymethylcellulose, hydroxyethylcellulose, methylhydroxyethylcellulose, hydroxypropyl cellulose or hydroxypropyl methylcellulose, especially with preferably from 20 to 25% by weight carboxymethylcellulose. Synthetic thickeners that may be mentioned are, for example, those based on poly(meth)acrylic acids or poly(meth)acrylamides and also polyalkylene glycols having a molecular weight of e.g. from 2000 to 20 000, for example polyethylene glycol or polypropylene glycol or the mixed polyalkylene glycols of ethylene oxide and propylene oxide.

The inks comprise such thickeners, for example, in an amount of from 0.01 to 2% by weight, especially from 0.01 to 1% by weight and preferably from 0.01 to 0.5% by weight, based on the total weight of the ink.

The inks may also comprise buffer substances, e.g. borax, borates, phosphates, polyphosphates or citrates. Examples that may be mentioned include borax, sodium borate, sodium tetraborate, sodium dihydrogen phosphate, disodium hydrogen phosphate, sodium tripolyphosphate, sodium pentapolyphosphate and sodium citrate. They are used especially in amounts of from 0.1 to 3% by weight, preferably from 0.1 to 1% by weight, based on the total weight of the ink, in order to establish a pH value of, for example, from 4 to 9, especially from 5 to 8.5.

As further additives, the inks may comprise surfactants or humectants.

Suitable surfactants include commercially available anionic or non-ionic surfactants. As humectants in the inks according to the invention there come into consideration, for example, urea or a mixture of sodium lactate (advantageously in the form of a 50% to 60% aqueous solution) and glycerol and/or propylene glycol in amounts of preferably from 0.1 to 30% by weight, especially from 2 to 30% by weight.

Preference is given to inks having a viscosity of from 1 to 40 mPa·s, especially from 1 to 20 mPa·s and preferably from 1 to 10 mpa·s.

The inks may also comprise customary additives, such as antifoam agents or especially preservatives that inhibit the growth of fungi and/or bacteria. Such additives are usually used in amounts of from 0.01 to 1% by weight, based on the total weight of the ink.

Preservatives that come into consideration include formaldehyde-yielding agents, e.g. paraformaldehyde and trioxane, especially aqueous, approximately 30 to 40% by weight formaldehyde solutions, imidazole compounds, e.g. 2-(4-thiazolyl)benzimidazole, thiazole compounds, e.g. 1,2-benzisothiazolin-3-one or 2-n-octyl-isothiazolin-3-one, iodine compounds, nitriles, phenols, haloalkylthio compounds or pyridine derivatives, especially 1,2-benzisothiazolin-3-one or 2-n-octyl-isothiazolin-3-one. A suitable preservative is e.g. a 20% by weight solution of 1,2-benzisothiazolin-3-one in dipropylene glycol (Proxel® GXL).

The inks may also comprise further additives, such as fluorinated polymers or telomers, e.g. polyethoxyperfluoroalcohols (Forafac® or Zonyl® products) in an amount of e.g. from 0.01 to 1% by weight, based on the total weight of the ink.

In inkjet printing, individual droplets of the ink are sprayed onto a substrate in a controlled manner from a nozzle. For this purpose, predominantly the continuous inkjet method and the drop-on-demand method are used. In the continuous inkjet method, the droplets are produced continuously and any droplets not required for the printing are conveyed to a collecting vessel and recycled, whereas in the drop-on-demand method droplets are produced and printed as required; that is to say droplets are produced only when required for the printing. The production of the droplets can be effected, for example, by means of a piezo-inkjet head or by means of thermal energy (bubble jet). Printing by means of a piezo-inkjet head and printing in accordance with the continuous inkjet method are preferred.

The present invention accordingly relates also to aqueous inks comprising the dye mixtures according to the invention and to the use of such inks in an inkjet printing method for the printing of various substrates, especially textile fibre materials, the definitions and preferred meanings mentioned above applying to the dye mixtures, the inks and the substrates.

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

### EXAMPLE 1

100 parts of a cotton fabric are introduced at a temperature of 60° C. into a dyebath comprising 3.0 parts of the dye of formula 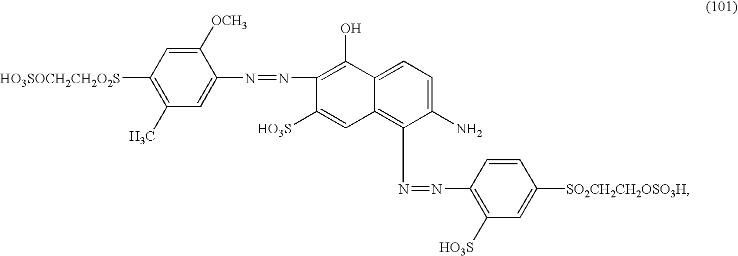
3.0 parts of the dye of formula 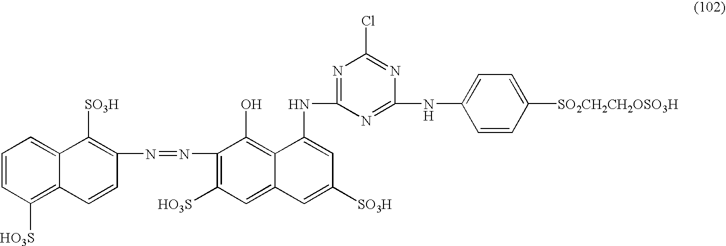
and 60 parts of sodium chloride in 1000 parts of water. After 45 minutes at 60° C., 20 parts of calcined soda are added. The temperature of the dyebath is maintained at 60° C. for a further 45 minutes. The dyed fabric is then rinsed and dried in the customary manner. A deep-red dyeing having good fastness properties is obtained.

### EXAMPLE 2

Following the procedure given in Example 1 but using instead of 3.0 parts of the dye of formula (101) 0.6 part of the dye of formula (101) and instead of 3.0 parts of the dye of formula (102) 5.4 parts of the dye of formula (102) a deep-red dyeing having good fastness properties is likewise obtained.

### EXAMPLE 3

Following the procedure given in Example 1 but using instead of 3.0 parts of the dye of formula (101) 3.0 parts of the dye of formula 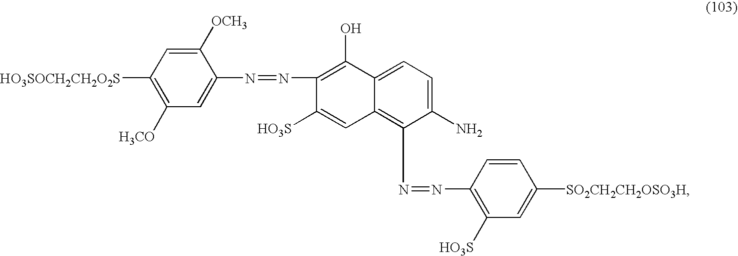
and instead of 3.0 parts of the dye of formula (102) 3.0 parts of the dye of formula 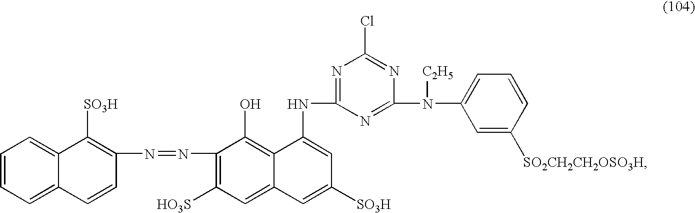
a deep-red dyeing having good fastness properties is likewise obtained.

### EXAMPLES 4 to 60

Following the procedure given in Example 1 but using instead of 3.0 parts of the dye of formula (101) 3.0 parts of the dye of general formula

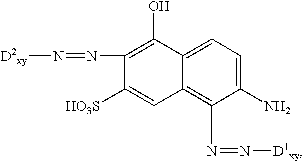

wherein D¹_{xy} and D²_{xy} each correspond to the radical given in Table 1 and those radicals are as defined in Table 2, deep-red dyeings having good fastness properties are likewise obtained.

TABLE 1

| Ex. | D¹_{xy} | D²_{xy} | colour shade |
|---|---|---|---|
| 4 | D₁₁ | D₁₁ | deep-red |
| 5 | D₁₂ | D₁₂ | deep-red |
| 6 | D₁₃ | D₁₃ | deep-red |
| 7 | D₁₄ | D₁₄ | deep-red |
| 8 | D₁₅ | D₁₅ | deep-red |
| 9 | D₁₆ | D₁₆ | deep-red |
| 10 | D₁₇ | D₁₇ | deep-red |
| 11 | D₁₈ | D₁₈ | deep-red |
| 12 | D₁₉ | D₁₉ | deep-red |
| 13 | D₂₀ | D₂₀ | deep-red |
| 14 | D₂₁ | D₂₁ | deep-red |
| 15 | D₂₂ | D₂₂ | deep-red |
| 16 | D₂₃ | D₂₃ | deep-red |
| 17 | D₂₄ | D₂₄ | deep-red |
| 18 | D₂₅ | D₂₅ | deep-red |
| 19 | D₂₆ | D₂₆ | deep-red |
| 20 | D₁₀ | D₁₂ | deep-red |
| 21 | D₁₂ | D₁₀ | deep-red |
| 22 | D₁₀ | D₁₃ | deep-red |
| 23 | D₁₃ | D₁₀ | deep-red |
| 24 | D₁₀ | D₂₀ | deep-red |
| 25 | D₂₁ | D₁₃ | deep-red |
| 26 | D₁₀ | D₁₄ | deep-red |
| 27 | D₁₀ | D₁₅ | deep-red |
| 28 | D₁₀ | D₁₆ | deep-red |
| 29 | D₁₀ | D₁₇ | deep-red |
| 30 | D₁₀ | D₁₈ | deep-red |
| 31 | D₁₀ | D₁₉ | deep-red |
| 32 | D₁₀ | D₂₁ | deep-red |
| 33 | D₁₀ | D₂₂ | deep-red |
| 34 | D₁₀ | D₂₃ | deep-red |
| 35 | D₁₀ | D₂₄ | deep-red |
| 36 | D₁₀ | D₂₅ | deep-red |
| 37 | D₁₀ | D₂₆ | deep-red |
| 38 | D₁₃ | D₂₀ | deep-red |
| 39 | D₁₄ | D₁₁ | deep-red |
| 40 | D₂₉ | D₃₂ | deep-red |
| 41 | D₂₉ | D₃₀ | deep-red |
| 42 | D₂₉ | D₁₀ | deep-red |
| 43 | D₂₉ | D₃₁ | deep-red |
| 44 | D₃₃ | D₃₃ | deep-red |
| 45 | D₂₈ | D₂₈ | deep-red |
| 46 | D₂₈ | D₂₇ | deep-red |
| 47 | D₁₀ | D₂₉ | deep-red |
| 48 | D₁₀ | D₃₁ | deep-red |
| 49 | D₁₁ | D₃₁ | deep-red |
| 50 | D₃₁ | D₁₁ | deep-red |
| 51 | D₃₃ | D₁₁ | deep-red |
| 52 | D₃₄ | D₃₄ | deep-red |
| 53 | D₂₁ | D₃₄ | deep-red |
| 54 | D₃₄ | D₂₁ | deep-red |
| 55 | D₃₄ | D₁₀ | deep-red |
| 56 | D₁₀ | D₃₄ | deep-red |
| 57 | D₃₁ | D₃₁ | deep-red |
| 58 | D₁₀ | D₃₃ | deep-red |
| 59 | D₁₃ | D₃₂ | deep-red |
| 60 | D₁₉ | D₂₁ | deep-red |

TABLE 2
D_{xy}

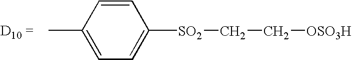

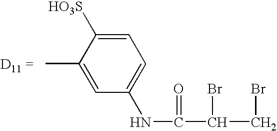

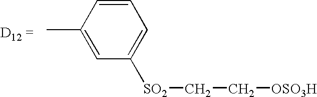

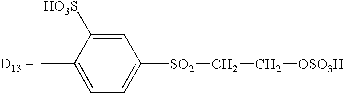

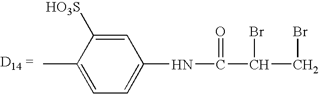

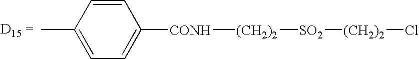

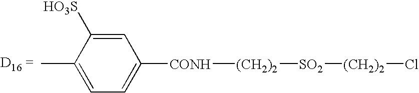

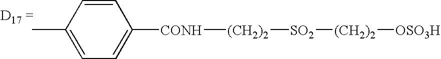

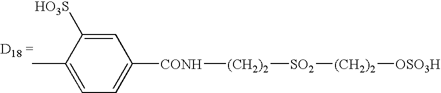

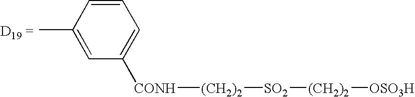

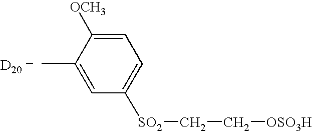

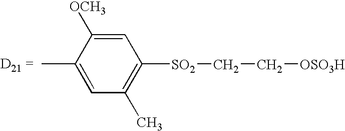

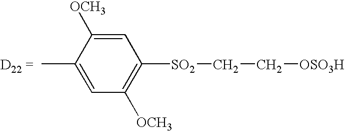

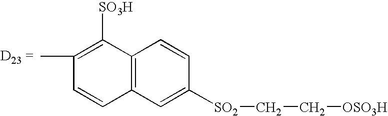

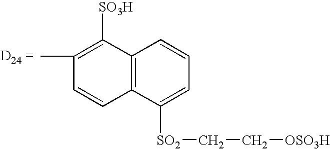

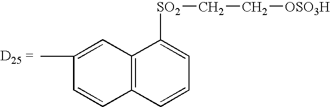

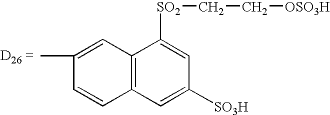

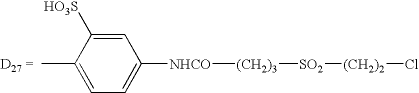

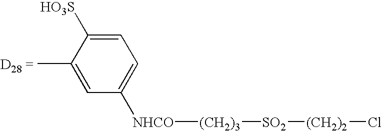

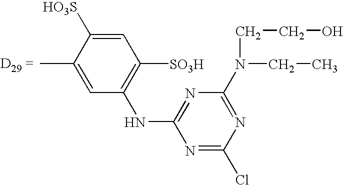

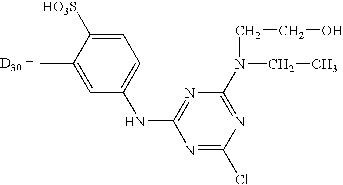

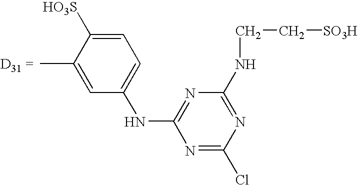

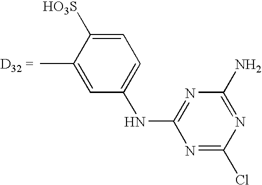

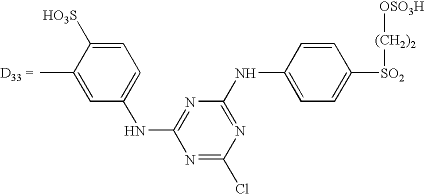

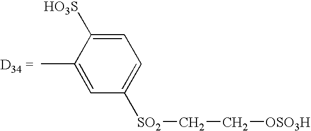

### EXAMPLES 61 to 70

Following the procedure given in Example 1 but using instead of 3.0 parts of the dye of formula (102) 3.0 parts of the dye of formula 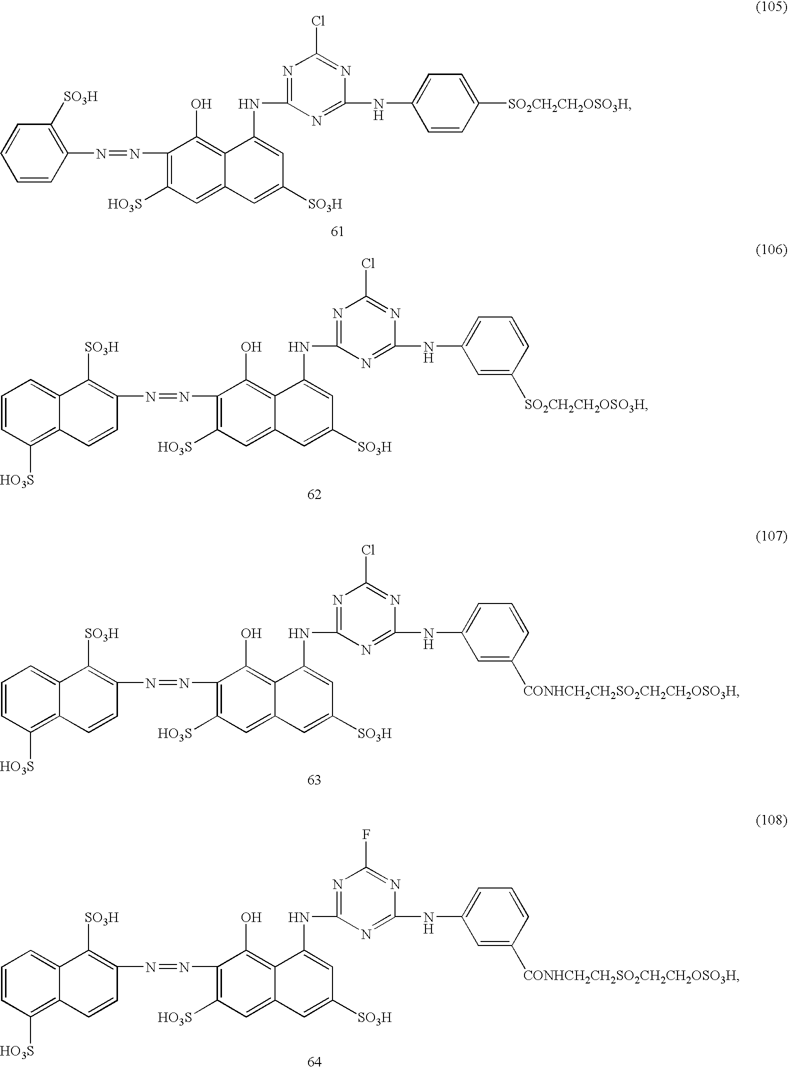
or 3.0 parts of the dye of the above-mentioned formula
65 (2ba),
66 (2bb),
67 (2bc),
68 (2bd),
69 (2be) or
70 (2bf)
   red dyeings having good fastness properties are likewise obtained.

1. A dye mixture comprising:
at least one dye of formula 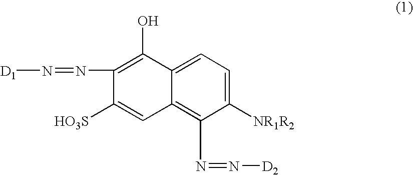
together with at least one dye from the group of formulae 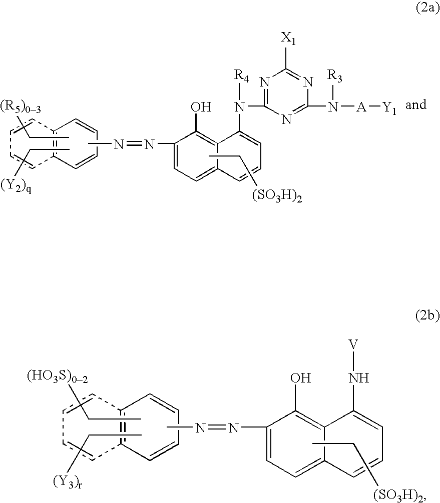
wherein
R₁ and R₂ are each independently of the other hydrogen or unsubstituted or substituted C₁-C₈alkyl,
R₃ and R₄ are each independently of the other hydrogen or unsubstituted or substituted C₁-C₄alkyl,
(R₅)₀₋₃ denotes from 0 to 3 identical or differing substituents from the group halogen, C₁-C₄alkyl,
C₁-C₄alkoxy, carboxy, nitro and sulfo,
A is unsubstituted or substituted phenylene, unsubstituted or substituted naphthylene, or
C₂-C₈alkylene which may be interrupted by oxygen,
D₁ and D₂ are each independently of the other the radical of a diazo component of the benzene or naphthalene series,
q and r are each independently of the other the number 0 or 1,
X₁ is halogen or a non-fibre-reactive substituent, and
Y₁ and Y₂ are each independently of the other a radical of formula
—SO₂—Z (3a),
—NH—CO—(CH₂)ₘ—SO₂—Z (3b),
—CONH—(CH₂)ₙ—SO₂—Z (3c),
—NH—CO—CH(Hal)—CH₂-Hal (3d),
—NH—CO—C(Hal)═CH₂ (3e) or 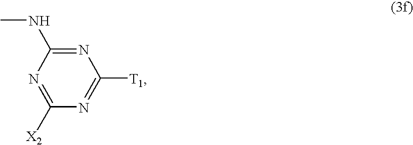
wherein
X₂ is halogen, T₁ independently has the definition of X₂, is a non-fibre-reactive substituent or is a fiber-reactive radical of formula
—NH—(CH₂)₂₋₃—SO₂—Z (4a),
—NH—(CH₂)₂₋₃—O—(CH₂)₂₋₃—SO₂—Z (4b), 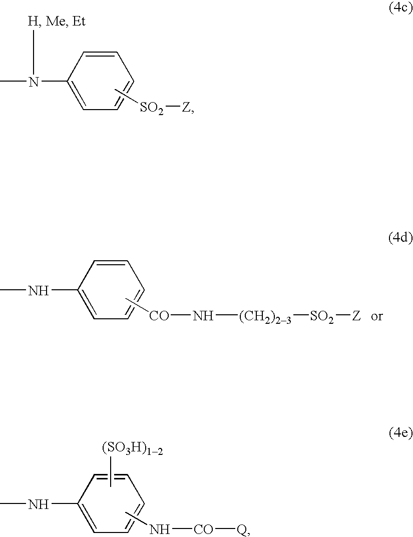
wherein
Z is vinyl or a radical —CH₂—CH₂—U and U is a group that is removable under alkaline conditions,
Q is a group —CH(Hal)—CH₂-Hal or —C(Hal)═CH₂,
m and n are each independently of the other the number 2, 3 or 4,
Hal is halogen,
Y₃ is a radical of the above-mentioned formula (3a), or is a radical of formula 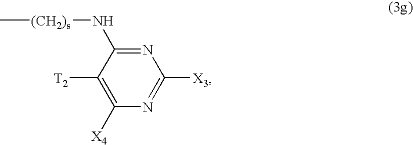
wherein
s is the number 0 or 1, and
X₃ is halogen or C₁-C₄akylsulfonyl,
X₄ is halogen or C₁-C₄alkyl and
T₂ is hydrogen, cyano or halogen, and
V is C₂-C₄alkanoyl, benzoyl which is unsubstituted or is substituted by a radical of formula (3g), or is a radical of formula 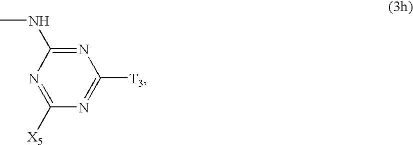
wherein
X₅ is halogen, and
T₃ is a non-fibre-reactive substituent.

2. A dye mixture according to claim 1, wherein
R₁ and R₂ are hydrogen.

3. A dye mixture according to claim 1, wherein
R₃ is hydrogen, methyl or ethyl and R₄ is hydrogen.

4. A dye mixture according to claim 1, wherein
X₁ is chlorine.

5. A dye mixture according to claim 1, wherein
D₁ and D₂ are each independently of the other a radical of formula 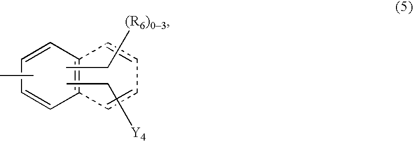
wherein
(R₆)₀₋₃ denotes from 0 to 3 identical or differing substituents from the group halogen, C₁-C₄alkyl,
C₁-C₄alkoxy, carboxy, nitro and sulfo, and
Y₄ is a radical of formula (3a), (3b), (3c), (3d), (3e) or (3f) according to claim 1.

6. A dye mixture according to claim 1, wherein
D₁ and D₂ are each independently of the other a radical of formula 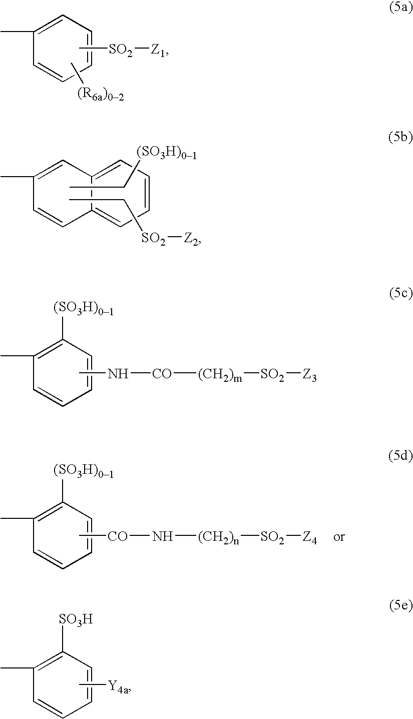
wherein
(R₆ₐ)₀₋₂ denotes from 0 to 2 identical or differing substituents from the group halogen, C₁-C₄alkyl,
C₁-C₄alkoxy and sulfo,
Y₄ₐ is α,β-dibromopropionylamino or α-bromoacryloylamino,
m is the number 2 or 3,
n is the number 2 or 3, and
Z₁, Z₂, Z₃ and Z₄ are each independently of the others vinyl, p-chloroethyl or -sulfatoethyl.

7. A dye mixture according to claim 1, wherein
-A—Y, is a radical of formula 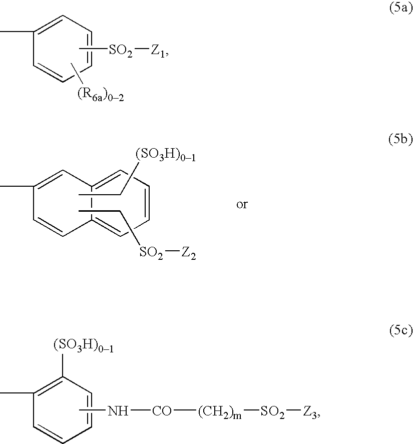
wherein
(R₆ₐ)₀₋₂ denotes from 0 to 2 identical or differing substituents from the group halogen, C₁-C₄alkyl,
C₁-C₄alkoxy and sulfo,
m is the number 2 or 3, and
Z₁, Z₂ and Z₃ are each independently of the others vinyl, β-chloroethyl or β-sulfatoethyl.

8. A dye mixture according to claim 1, wherein
R₁ and R₂ are hydrogen,
D₁ is a radical of formula 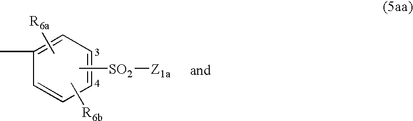
D₂ is a radical of formula 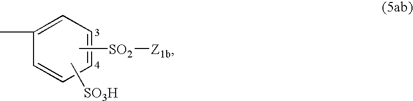
wherein
R₆ₐ and R_{6b} are each independently of the other methyl or methoxy, and
Z₁ₐ and Z_{1b} are each independently of the other vinyl, β-chloroethyl or β-sulfatoethyl.

9. A dye mixture according to claim 1, wherein the dye of formula (2a) is a dye of formula 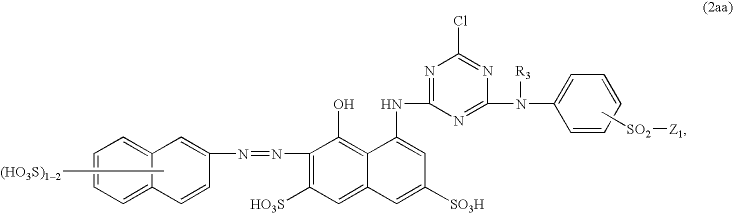
wherein
R₃ is hydrogen, methyl or ethyl, and
Z₁ is vinyl, β-chloroethyl or β-sulfatoethyl.

10. A method of dyeing or printing of hydroxyl-group-containing or nitrogen-containing fibre materials, which comprises contacting said materials with a tinctorially effective amount of a dye mixture according to claim 1.

11. A method according to claim 10, wherein cellulosic fibre materials are dyed or printed.

12. An aqueous ink comprising a dye mixture according to claim 1.

13. A method of printing of hydroxyl-group-containing or nitrogen-containing fibre materials by the inkjet printing method, which comprises contacting said materials with a tinctorially effective amount of an aqueous ink according to claim 12.

14. A method according to claim 10, wherein cotton-containing fibre materials are dyed or printed.

15. A method according to claim 13, wherein hydroxyl-group-containing fibre materials are dyed or printed.
